(19) United States
(12) Patent Application Publication
(10) Pub. No.: US 2024/0236214 A1
(43) Pub. Date: Jul. 11, 2024

(54) Transient Hiding of Internet Protocol Header Options

(71) Applicant: Huawei Technologies Co., Ltd., Shenzhen (CN)

(72) Inventor: Donald Eggleston Eastlake, III, Apopka, FL (US)

(21) Appl. No.: 18/412,246

(22) Filed: Jan. 12, 2024

Related U.S. Application Data
(63) Continuation of application No. PCT/US2022/036791, filed on Jul. 12, 2022.
(60) Provisional application No. 63/220,632, filed on Jul. 12, 2021.

(51) Int. Cl. H04L 69/22; H04L 45/74; H04L 69/16

(52) U.S. Cl. CPC H04L 69/22; H04L 45/74; H04L 69/169

(57) ABSTRACT

A method implemented by a network node for processing packets with header options. The network node receives a packet that includes an Internet Protocol (IP) header (e.g., IP version 4 (IPv4) or IP version 6 (IPv6) header). The network node determines that the IP header includes one or more options. The network node modifies an options indicator field in the IP header from a first options protocol value to a selected opaque protocol value. The network node transmits the packet toward the destination of the packet.

### CROSS-REFERENCE TO RELATED APPLICATIONS

This application is a continuation of International Patent Application No. PCT/US2022/036791 filed on Jul. 12, 2022, by Futurewei Technologies, Inc., and titled “Transient Hiding of Internet Protocol Header Options,” which claims priority to U.S. Provisional Patent Application No. 63/220,632, filed Jul. 12, 2021 by Futurewei Technologies, Inc., and titled “Transient Hiding of Internet Protocol Header Options.” Both of the aforementioned patent applications are hereby incorporated by reference in their entireties.

### TECHNICAL FIELD

The present disclosure is generally related to the field of network communications and, in particular, to systems and methods for transient hiding of Internet Protocol (IP) header options.

### BACKGROUND

The Internet is based on the IP protocol. The first widely deployed version of IP was IP version 4 (IPv4) as specified in Internet Engineering Task Force (IETF) Request for Comments (RFC) 791. Large parts of the Internet employ IP version 6 (IPv6) as specified in IETF RFC 8200. One reason for this transition is the limited number (232) of IPv4 addresses, which have been effectively exhausted, compared with the larger number (2128) of IPv6 addresses.

### SUMMARY

A first aspect relates to a method implemented by a network node for processing packets with header options. The network node receives a packet that includes an IP header (IPv4 or IPv6 header). The network node determines that the IP header includes one or more options. The network node modifies an options indicator field in the IP header from a first options protocol value to a selected opaque protocol value. The network node transmits the packet toward the destination of the packet.

A second aspect relates to a method implemented by a network node or processing packets with header options. The network node receives a packet that includes an IP header (IPv4 or IPv6 header). The network node determines that an options indicator field in the IP header includes a selected opaque protocol value. The network node modifies the options indicator field from the opaque protocol value to an options value indicating that the IP header comprises one or more options. The network node transmits the packet toward the destination of the packet.

A third aspect relates to a network node that includes a memory storing instructions and a processor coupled to the memory. The processor executes the instructions to cause the network node to perform the method of any of the preceding aspects.

Optionally, in a first implementation according to any of the preceding aspects, the one or more options includes hop-by-hop header options.

Optionally, in a second implementation according to any of the preceding aspects or implementation thereof, the options indicator field is a Next Header Field.

Optionally, in a third implementation according to any of the preceding aspects or implementation thereof, the options indicator field is a Protocol field.

Optionally, in a fourth implementation according to any of the preceding aspects or implementation thereof, the options value or the first options protocol value is 0.

Optionally, in a fifth implementation according to any of the preceding aspects or implementation thereof, the method further includes, or the processor further executes instructions for inserting a flow identifier in the IP header to identify a packet flow.

Optionally, in a sixth implementation according to any of the preceding aspects or implementation thereof, the method further includes, or the processor further executes instructions for modifying an Internet Header Length (IHL) value, a Header Checksum (HC) value, and/or a Total Length (TL) value.

Optionally, in a seventh implementation according to any of the preceding aspects or implementation thereof, the method further includes, or the processor further executes instructions for adding new fields for saving the IHL value, the HC value, and/or the TL value.

Optionally, in an eighth implementation according to any of the preceding aspects or implementation thereof, the method further includes, or the processor further executes instructions for removing any no longer necessary fields that was added to the IP header.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network in accordance with an embodiment of the present disclosure.

FIG. 2 is a schematic diagram of an IP packet in accordance with an embodiment of the present disclosure.

FIG. 3 is a schematic diagram of an IPv6 header in accordance with an embodiment of the present disclosure.

FIG. 4 is a schematic diagram of an IPv6 Extension Header in accordance with an embodiment of the present disclosure.

FIG. 5 is a schematic diagram of an IPv4 header in accordance with an embodiment of the present disclosure.

FIG. 6 is a schematic diagram of a modified IPv4 header in accordance with an embodiment of the present disclosure.

FIG. 7 is a flowchart illustrating a method for modifying a packet in accordance with an embodiment of the present disclosure.

FIG. 8 is a flowchart illustrating a method for modifying a packet in accordance with an embodiment of the present disclosure.

FIG. 9 is a schematic diagram of a network node according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

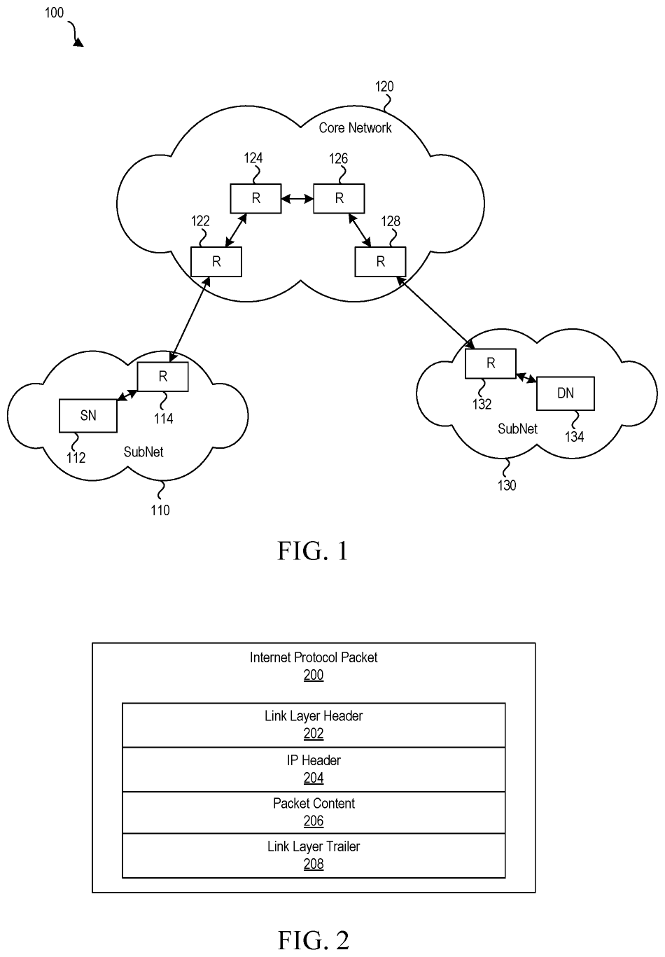

FIG. 1 is a schematic diagram of a network 100 in accordance with an embodiment of the present disclosure. The network 100 illustrates the path an Internet Protocol (IP) packet may take from a source node (SN) 112 that created the packet to a destination node (DN) 134 that consumes the packet. As depicted in FIG. 1, the SN 112 may be located in a sub-network (subnet) 110, and the DN 134 may be located in a subnet 130. A subnet is a logical subdivision of an IP network. Non-limiting examples of subnets may be datacenters, offices of a company, or the like. For example, organizations may use a subnet to subdivide large networks into smaller subnetworks to help minimize traffic and increase network speeds.

In the depicted embodiment, the packet travels from the SN 112 to a router 114 of the subnet 110. The router 114 sends the packet to a core network 120 where the packet may be routed through multiple routers (e.g., router 122→router 124→router 126→router 128) until the packet is transmitted to a router 132 of the subnet 130. The router 132 then routes the packet to the DN 134. Although not illustrated, the packet may pass through other routers along a path to the DN 134.

The core network 120 may for example, be the core Internet, also referred to as the

Internet backbone. The core network 120 includes high-bandwidth routers that move traffic from its source over the best available path toward its destination. The core network 120 may include many individual high-speed fiber-optic networks operated by various Internet Service Providers (ISPs) that peer with each other to create the core network 120.

One issue with current networks is the handling of IP packets with header options. A header option is a set of optional header fields that may contain data for network testing, that may specify delivery parameters at each hop on the path or at the destination, or that may provide padding (e.g., align the next option on a 16-bit or 32-bit boundary). Header options are available for both IPv4 and IPv6. For example, in IPv4, a record-route option is used to record the IP routers that handle the packet, a timestamp option is used to record the time of packet processing by a router, and a strict-source-route option is used by the source to predetermine a route for the packet as the packet travels through the network. In IPv6, a header option is also referred to an Extension Header. At this time, Internet Engineering Task Force (IETF) specified extension headers for IPv6 include hop-by-hop options, fragment, destination options, routing, authentication, and encapsulating security payload. Hop-by-hop options specify delivery parameters at each hop on the path to the destination host (i.e., information that is intended to be examined by every router along the path). Fragment specifies how to perform IPv6fragmentation and reassembly services. Destination options specifies packet delivery parameters for either intermediate destination devices or the final destination host. Routing defines strict source routing and loose source routing for the packet. With strict source routing, each specified intermediate destination device must be a single hop away. With loose source routing, specified intermediate destination devices can be one or more hops away. Authentication provides authentication, data integrity, and anti-replay protection. Encapsulating security payload provides data confidentiality, data authentication, and anti-replay protection for encapsulated security payload (ESP) packets. Additional extension headers have been proposed, and likely more extension headers will be proposed and specified in the future.

In the early days of the Internet, much of the traffic was text, transmission speeds were relatively slow, and IP routers were commonly small general-purpose computers. Under these conditions, parsing IP headers with various options or combinations of options, handling variable length options, etc., was relatively easy and did not impact throughput or latency much. However, as the Internet increased in size, bandwidth grew because of more voluminous media such as video, transmission speeds increased enormously, latency/responsiveness requirements became much more stringent, and IP routers, especially in the core of the Internet, typically became less flexible and more specialized. To be able to handle data faster and more efficiently, such core IP routers are increasingly divided into a forwarding plane and a control plane where the forwarding plane handles the usual data forwarding, while the control plane handles routing control messages and other packets that the data plane cannot handle. In some IP routers, the forwarding plane is implemented with Application Specific Integrated Circuits (ASICs) that are inflexible and may require fields in an IP packet header to be at a fixed offset from the beginning of the packet. Meanwhile, the control plane may be implemented through a relatively low power general purpose computer which can only handle a relatively small number of packets per unit time. For these reasons, many IP routers could not or do not implement many or any types of IPv4 header options or IPv6 hop-by-hop options except through the control plane, which is relatively slow. Sending packets with such IP header options to the control plane can overwhelm the control plane and interfere with routing control messages or other critical functions. Very often, particularly for IP routers handling a large amount of traffic, a strategy is adopted of either ignoring IPv4/IPv6 header options or dropping IP packets with such header options. Neither strategy allows such options to have the intended effect. Even if all the local IP routers within Subnets 110 and 130 are upgraded to properly handle IPv4 header options or IPv6 hop-by-hop header options (or to at least have improved handling of such options), it will be some time before the core network 120 would be upgraded in the same way. So, the risk of the mishandling such options in the core network would remain.

FIG. 2 is a schematic diagram of an IP packet 200 in accordance with an embodiment of the present disclosure. The IP packet 200 is an example a packet traversing the network 100 from the SN 112 to the DN 134. The IP packet 200 includes a link layer header 202, an IP header 204, a packet content 206, and a link layer trailer 208. The link layer header 202 (or layer 2/data link layer header) contains the physical link source and the link destination addresses of the frame (i.e., hardware/media access control (MAC) addresses), control information (e.g., indicates whether the IP packet 200 is a data packet or the IP packet 200 is used for control functions like error and flow control or link management etc.), and information as to the type of data enveloped between the link layer header 202 and the link layer trailer 208. The link layer data type information might indicate that the packet is an IPv4 packet or an IPv6 packet. The IP header 204 (or layer 3/network layer header) contains the logical source and the destination addresses of the IP packet 200 (i.e., the IP addresses). A network router routes the IP packet 200 at the network layer/layer 3 using information contained in the IP header 204. The packet content 206 contains the packet payload (i.e., the actual data being transported by the IP packet 200). The link layer trailer 208 contains error detection and error correction bits.

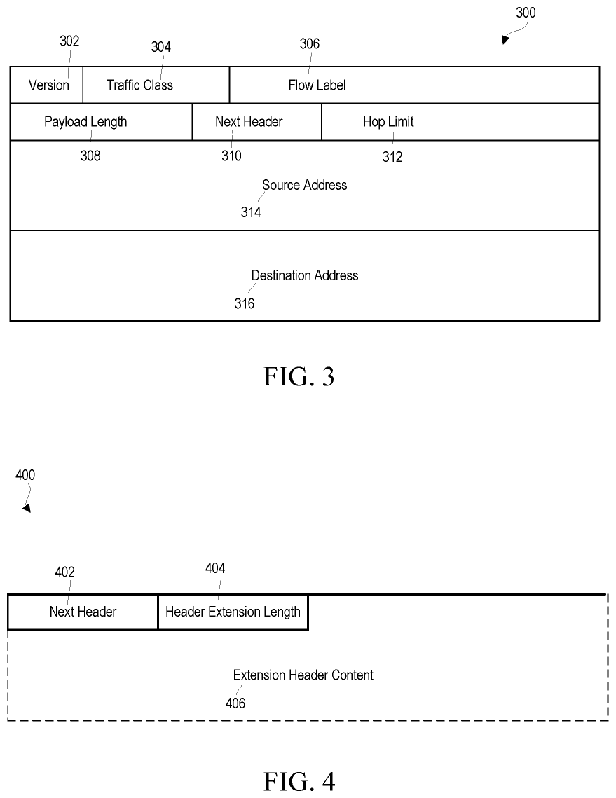

FIG. 3 is a schematic diagram of an IPv6 header 300 in accordance with an embodiment of the present disclosure. The IPv6 header 300 is an example the IP header 204 in FIG. 2. The IPv6 header 300 includes a version field 302, a traffic class field 304, a flow label field 306, a payload length field 308, a next header field 310, a hop limit field 312, a source address field 314, and a destination address field 316.

The version field 302 is a 4-bit field and contains the value 6 (i.e., 0110) to indicate that the IP version is IPv6.

The traffic class field 304 is an 8-bit field and indicates the packet's class or priority. The first 6 bits of the traffic class field 304 represent the type of service or services to apply to the packet by a router, and the last 2bits may be used for explicit congestion notification (ECN).

The flow label field 306 is a 20-bit field and indicates that the packet belongs to a specific sequence of packets (i.e., a packet flow between a source and destination). To distinguish a given flow, a router can use the packet's source address, destination address, and flow label.

The payload length field 308 is a 16-bit field and indicates the length of the IPv6 payload. The payload length field 308 includes any extension headers (i.e., option fields) and the upper-layer protocol data unit (PDU). With 16 bits, an IPv6 payload of up to 65,535 bytes can be indicated. For payload lengths greater than 65,535 bytes, the payload length field 308 is set to 0 and the jumbo payload option is used in the hop-by-hop options extension header; however, there are few networks that can handle such very large packets.

The next header field 310 is an 8-bit field and indicates either the type of the first extension header (if present) or the protocol in the upper-layer PDU (such as Transmission Control Protocol (TCP), User Datagram Protocol (UDP), or Internet Control Message Protocol version 6 (ICMPv6)). For example, a value of 17 in the next header field 310 indicates that the header is immediately followed by a UDP message and a value of 6 indicates that the header is followed by a TCP message.

The hop limit field 312 is an 8-bit field and indicates the maximum number of links over which the IPv6 packet can travel before being discarded.

The source address field 314 is a 128-bit field and indicates the IPv6 address of the originating host.

The destination address field 316 is a 128-bit field and indicates the IPv6 address of the current destination node. In most cases, the destination address field 316 is set to the final destination address. However, if a routing extension header is present, the destination address field 316 might be set to the address of the next intermediate destination.

FIG. 4 is a schematic diagram of an IPv6 Extension Header 400 in accordance with an embodiment of the present disclosure. The IPv6 Extension Header 400 is an example an Extension Header or option that may be added to the IPv6 header 300 in FIG. 3. The IPv6 Extension Header 400 contains supplementary information used by network devices (such as routers, switches, and endpoint hosts) to decide how to direct or process an IPv6 packet. For example, the IPv6 Extension Header 400 may be used for specifying hop-by-hop options, fragment, destination options, routing, authentication, and encapsulating security payload as defined by IETF. Extension headers may be placed between the IPv6 header and the upper-layer header in a packet. The length of each extension header is an integer multiple of 8 octets. This allows subsequent extension headers to start at a point aligned on an 8-octet boundary.

The IPv6 Extension Header 400 includes a next header field 402, a header extension length field 404, and an extension header content field 406. The next header field 402 indicates the type of header following the IPv6 Extension Header 400 (e.g., another extension header or an upper layer header). Each Extension header is identified by the Next Header field in the preceding header. The header extension length field 404 contains the length of the IPv6 Extension Header 400. The extension header content field 406 contains the content or data carried by the IPv6 Extension Header 400.

For “Hop-by-Hop Options” and “Destination Options”, the extension header content field 406 is further structured into options each of which, except for the one byte “pad1” option, uses a type-length-value (TLV) format having an 8-bit option type field, followed by an 8-bit option length field, followed by the option value.

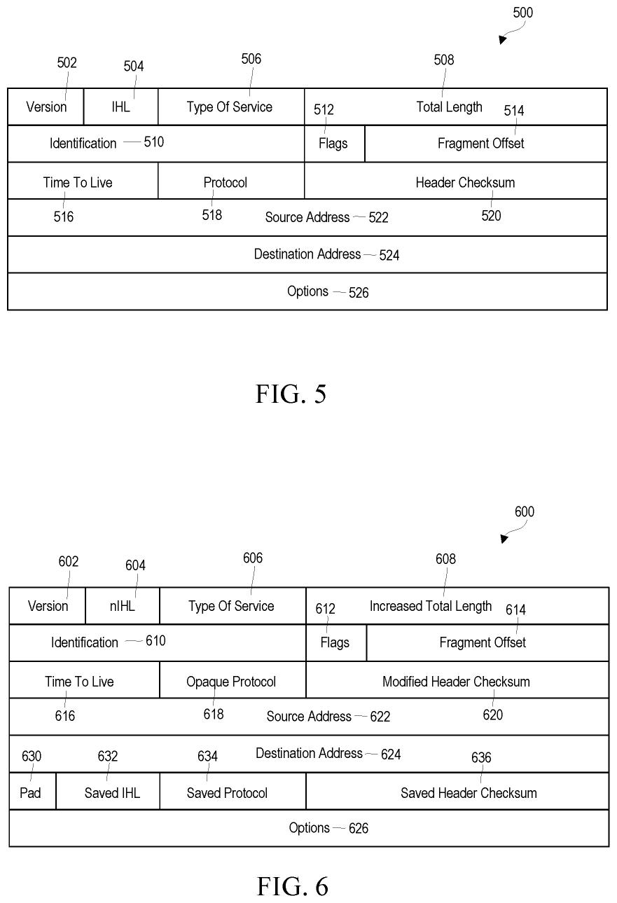

FIG. 5 is a schematic diagram of an IPv4 header 500 in accordance with an embodiment of the present disclosure. The IPv4 header 500 is an example the IP header 204 in FIG. 2. In contrast to the IPv6 header 300 in FIG. 3, the IPv4 header 500 does not use header extensions for options. Instead, option fields are integrated in the IPv4 header 500. For example, fragmentation, where an IP packet is split into pieces that can be later combined because the packet might be too big to traverse part of its path, is not indicated through an extension header for the IPv6 header 300. Rather, fragmentation is indicated through fields directly in the IPv4 header 500. Similarly, because IPv4 options are considered part of the IPv4 header 500, the size of the options can be determined from an IHL field which indicates the size of the IPv4 header 500.

As depicted in FIG. 5, the IPv4 header 500 includes a version field 502, an IHL field 504, a type of service (ToS) field 506, a total length field 508, an identification field 510, a flags field 512, a fragment offset field 514, a time to live (TTL) field 516, a protocol field 518, a header checksum field 520, a source address field 522, a destination address field 524, and an options field 526. The IPv4 header 500 is variable in size due to the options field 526 being an optional field.

The version field 502 is a 4-bit field and contains the value 4 to indication that the IP version is IPv4.

The IHL field 504 is a 4-bit field and indicates the size of the IPv4 header 500 as stated above. The minimum value for IHL field 504 is 5, which indicates a length of 5×32 bits=160 bits=20 bytes. As a 4-bit field, the maximum value is 15; this means that the maximum size of the IPv4 header 500 is 15×32 bits=480 bits=60 bytes.

The type of service (ToS) field 506 is an 8-bit field (also referred to as a differentiated service (DiffServ) field) and is used to classify IP packets so that routers can make quality of service (QoS) decisions about what path packets should traverse across the network (e.g., specify priority and request a route for low-latency, high-throughput, or highly-reliable service). The ToS field 506 is similar to the traffic class field 304 of the IPv6 header 300 in FIG. 3. In some implementations, the first 6 bits of the ToS field 506 contain a value called the Differentiated Services Code Point (DSCP). DSCP is a mechanism used for classifying network traffic (e.g., real-time data streaming) on IP networks. The last 2 bits of the ToS field 506 (also referred to as the Explicit congestion notification (ECN) field) can be used to enable end-to-end congestion notification between two endpoints on IP based networks. ECN is an optional feature available when both endpoints and the underlying network support ECN.

The total length field 508 is a 16-bit field and indicates the entire packet size in bytes, including header and data.

The identification field 510 is a 16-bit field and is primarily used for uniquely identifying the group of fragments of a single IP packet or datagram.

The flags field 512 is a 3-bit field and is used to control or identify fragments.

The fragment offset field 514 is a 13-bit field and indicates the offset, in units of eight-byte blocks, of a particular fragment relative to the beginning of the original unfragmented IP packet or datagram.

The time to live (TTL) field 516 is an 8-bit field and indicates the maximum number of links over which the IPv4 packet can travel (i.e., a hop count) before being discarded. When the TTL field 516 hits zero, a router discards the packet and typically sends an Internet Control Message Protocol (ICMP) time exceeded message to the sender.

The protocol field 518 is an 8-bit field and defines the protocol used in the data portion of the IP packet or datagram. The protocol field 518 is similar to the next header field 310 of the IPv6 header 300 in FIG. 3.

The header checksum field 520 is a 16-bit field and is used for error-checking of the IPv4 header 500. A checksum is a small-sized block of data derived from another block of digital data for the purpose of detecting errors that may have been introduced during transmission or storage. For example, when a packet arrives at a router, the router calculates the checksum of the IPv4 header 500 and compares the checksum to the value in the header checksum field 520. If the values do not match, the router discards the packet.

The source address field 522 is a 32-bit field and specifies the IPv4 address of the sender of the packet. The address in the source address field 522 may be changed in transit by a network address translation device.

The destination address field 524 is 32-bit field and specifies the IPv4 address of the receiver of the packet. As with the source address, the address in the destination address field 524 may be changed in transit by a network address translation device.

The options field 526 is a variable-length field and can be used to specify one or more options (e.g., record route, time stamp, traceroute, strict source route, etc.). The value in the IHL field 504 must include enough extra 32-bit words to hold all the options plus any padding needed to ensure that the IPv4 header 500 contains an integer number of 32-bit words. If IHL is greater than 5 (e.g., between 6 and 15), it means that the options field 526 is present.

As discussed above, one issue with current networks is that some IP routers are not able to process IP packets that include header options or a particular header option (e.g., IPv6 Hop-by-Hop header options) and will simply drop the packet. To address this issue, the present disclosure modifies IP packets that include options (IPv4 header options or IPv6 Hop-by-Hop header options) to hide the options. The modification is then reversed after passing through the portion of the network where the header options may have presented problems. For example, in an embodiment, an egress router of a source subnet may modify IP packets when the IP packets leave the source subnet to hide options. Then an ingress router of a destination subnet detects the modification and reverses the modification as the IP packets enter the destination subnet to once again reveal such options. No changes are needed in IP packets without such options.

In an embodiment, a new “next protocol” value, referred to herein as an “opaque protocol” value, is selected for use to hide options. An opaque protocol value is a protocol value that does not correspond to any previously defined protocol or option. The selected opaque protocol value is known to a router(s) (e.g., stored as an opaque protocol parameter value) that performs the modification and a router(s) that reverses the modification. For example, if an IPv6 header has Hop-by-Hop options as indicated by a zero value in the next header field 310 in IPv6 header 300, a first router replaces the zero value with the opaque protocol value when leaving a source subnet area and a second router changes the opaque protocol value back to zero when arriving at the edge of a destination subnet. In general, intermediate routers (e.g., the core network IP routers) will not know the meaning of this opaque protocol value and will be unable to look further inside such packets, thus hiding the options. This will be no worse than such core routers ignoring such options and better than the routers discarding packets with such options.

For IPv6 packets, the replacement of the value in the next header field (e.g., next header field 310 in IPv6 header 300) has no effect on the length of the IPv6 packet. In some embodiments, replacing the value in the next header field may affect deeper analysis of the parts of the packet after the IPv6 header, but such analysis is usually not needed in the core network. Such analysis usually occurs at the border of, or in the interior of, peripheral subnets. Furthermore, to the extent that such analysis is for the purpose of identifying flows, this can be done at the source node or inside the source subnet and a flow identifier may be inserted in the flow label field 306 of the IPv6 header field for this purpose.

For IPv4 packets, the value in the protocol field (e.g., protocol field 518 in the IPv4 header 500) could similarly be replaced by the opaque protocol value. However, for IPv4 packets, the value in the IHL field (e.g., IHL field 504 in FIG. 5) would also be modified so that it appeared there were no options (e.g., setting the value of the IHL field to its minimum value 5). In an embodiment, the previous value of the protocol field and information as to the length of the options would both need to be preserved in new fields. The header checksum would need to be modified for the new header without options. The old header checksum could also be saved in a new field. The total length field (e.g., total length field 508 in FIG. 5) would also be updated to account for the new fields.

As an example, FIG. 6 is a schematic diagram of a modified IPv4 header 600 in accordance with an embodiment of the present disclosure. The modified IPv4 header 600 can be utilized in place of the IP header 204 in FIG. 2. The modified IPv4 header 600 includes a version field 602, a new Internet header length (nIHL) field 604, a type of service (ToS) field 606, an increased total length field 608, an identification field 610, a flags field 612, a fragment offset field 614, a TTL field 616, an opaque protocol field 618, a modified header checksum field 620, a source address field 622, a destination address field 624, and an options field 626.

The version field 602, ToS field 606, identification field 610, flags field 612, fragment offset field 614, TTL field 616, source address field 622, destination address field 624, and options field 626 are the same as the corresponding fields of the IPv4 header 500 described in FIG. 5. The modified IPv4header 600 increases the size of the header (i.e., the IPv4 header 500 in FIG. 5) by adding a pad field 630, a saved IHL field 632, a saved protocol field 634, and a saved header checksum field 636.

The increased total length field 608 is a 16-bit field. The increased total length field 608 indicates the entire packet size in bytes, including the increased header size.

The nIHL field 604 is a 4-bit field. In an embodiment, the nIHL field 604 is set to a value that makes it appear as though the modified IPv4header 600 has no options when in fact, the IPv4 header 600 may include one or more options. For instance, in an embodiment, the nIHL field 604 is set to a minimum IPv4 header size value of 5.

The opaque protocol field 618 is an 8-bit field. The opaque protocol field 618 replaces the protocol field in the IPv4 header (e.g., protocol field 518 in the IPv4 header 500). The opaque protocol field 618 contains a predetermined or selected opaque protocol value.

The modified header checksum field 620 is a 16-bit field and stores a modified checksum value.

The pad field 630 is merely for aligning the length of the modified IPv4 header 600 to a multiple of 32 bits.

As discussed above, the saved IHL field 632 stores the original IHL value (i.e., the value in the IHL field 504 in FIG. 5 prior to modification), the saved protocol field 634 stores the original protocol value that was in the protocol field (i.e., the value in the protocol field 518 in FIG. 5), and the saved header checksum field 636 stores the original checksum value (i.e., the value in the checksum field 520 in FIG. 5). In alternative embodiments, the original values could be saved in a variety of other ways including, for example, in a trailer at the end of the IPv4 packet.

Using the information in the modified IPv4 header 600, the options could then be later unhidden by restoring the protocol, header checksum, and IHL fields from their saved location, removing the added fields, and appropriately decreasing the value of the total length field. Alternatively, the header checksum could be regenerated when the IPv4 header with options is restored.

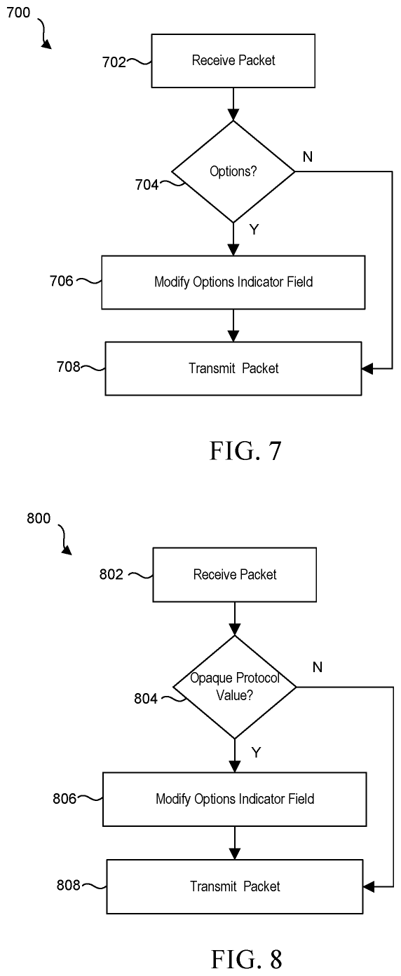

FIG. 7 is a flowchart illustrating a method 700 for modifying a packet in accordance with an embodiment of the present disclosure. The method 700 may be performed by a network node such as an egress node of a source sub-network of the packet (e.g., router 114 in FIG. 1). The network node, at step 702, receives a packet comprising an IP header. The packet may be an IPv4 packet (with an IPv4 header) or an IPv6 packet (with an IPv6 header).

The network node, at step 704, determines that the IP header includes one or more options (e.g., based on the options protocol value in the next header field of an IPv6 header or based on the IHL value of an IPv4 header). For instance, the options protocol value for an IPv6 header could be 0 indicating that the IP header includes hop-by-hop header options.

At step 706, the network node modifies an options indicator field in the IP header from a first options protocol value to a selected opaque protocol value. For IPv6 headers, the options indicator field is a Next Header Field. For IPv4 headers, the options indicator field is a Protocol field. In some embodiments, the network node may insert a flow identifier in the IP header to identify a packet flow. For IPv4 packets, the network node may modify an IHL field from a first IHL value to a second IHL value indicating a minimum IHL length (i.e., an IPv4 header without any options). The network node may also modify an HC value and a total length value. The network node may also add new fields for saving the original IHL value, the HC value, and the total length value. In some embodiments, the new fields are added to the packet header after a non-option portion of the IP header (i.e., prior to the options field). Alternatively, the new fields may be added in a trailer at an end of the packet (e.g., after the packet content 206 in FIG. 2).

The network node, at step 708, transmits the packet towards the intended destination.

FIG. 8 is a flowchart illustrating a method 800 for modifying a packet in accordance with an embodiment of the present disclosure. The method 700 may be performed by a network node such as an ingress node of a destination sub-network of the packet (e.g., router 132 in FIG. 1). The network node, at step 802, receives a packet comprising an IP header. The packet may be an IPv4 packet (with an IPv4 header) or an IPv6 packet (with an IPv6 header).

At step 804, the network node determines that an options indicator field (e.g., the next header field for IPv6 header or the protocol field for IPv4 header) in the IP header comprises a selected opaque protocol value.

The network node, at step 806, modifies the options indicator field from the opaque protocol value to an options value indicating that the IP header comprises one or more options. For example, the network node may modify the next header field for IPv6 header from the selected opaque protocol value back to 0 indicating that the packet includes hop-by-hop header options.

For IPv4 packets, the network node modifies the protocol field to indicate that packet includes one or more options. The network node may also modify the IHL value, the HC value, and the total length value back to the original value based on the values stored in the new fields (or the HC value may be calculated by the network node). The network node may remove any no longer necessary fields that were added to the IP header.

The network node, at step 808, transmits the packet towards the intended destination.

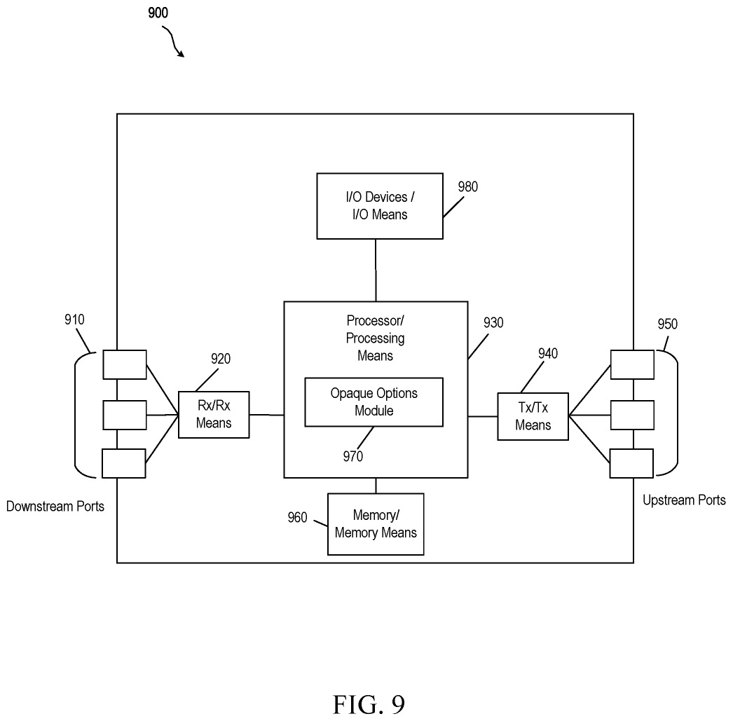

FIG. 9 is a schematic diagram of a network node 900 according to an embodiment of the disclosure. The network node 900 is suitable for implementing the disclosed embodiments as described herein. In an embodiment, the network node 900 may be a router or another device configured to perform the disclosed embodiments. For example, the network node 900 may be used to implement the method 700 of FIG. 7 and method 800 of FIG. 8 as disclosed herein.

The network node 900 comprises ingress ports 910 (or input ports 910) and receiver units (Rx) 920 for receiving data; a processor, logic unit, or central processing unit (CPU) 930 to process the data; transmitter units (Tx) 940 and egress ports 950 (or output ports 950) for transmitting the data; and a memory 960 for storing the data. The network node 900 may also comprise optical-to-electrical (OE) components and electrical-to-optical (EO) components coupled to the ingress ports 910, the receiver units 920, the transmitter units 940, and the egress ports 950 for egress or ingress of optical or electrical signals. The processor 930 may be implemented as one or more CPU chips, cores (e.g., as a multi-core processor), field-programmable gate arrays (FPGAs), ASICs, and digital signal processors (DSPs). The processor 930 is in communication with the ingress ports 910, receiver units 920, transmitter units 940, egress ports 950, and memory 960. The processor 930 comprises an opaque options module 970. The opaque options module 970 includes instructions that when executed by the processor 930 implements the processes described in the present disclosure. The inclusion of the opaque options module 970 therefore provides a substantial improvement to the functionality of the network node 900 and effects a transformation of the network node 900 to a different state. Alternatively, the opaque options module 970 is implemented as instructions stored in the memory 960 and executed by the processor 930.

The memory 960 may comprise one or more disks, tape drives, and solid-state drives and may be used as an over-flow data storage device, to store programs when such programs are selected for execution, and to store instructions and data that are read during program execution. The memory 960 may be, for example, volatile and/or non-volatile and may be a read-only memory (ROM), random access memory (RAM), ternary content-addressable memory (TCAM), static random-access memory (SRAM), or any other type of memory.

The network device 900 may also include input and/or output (I/O) devices/I/O means 980 for communicating data to and from a user. The I/O devices I/O means 980 may include output devices such as a display for displaying video data, speakers for outputting audio data, etc. The I/O devices I/O means 980 may also include input devices, such as a keyboard, mouse, trackball, etc., and/or corresponding interfaces for interacting with such output devices.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method comprising:
receiving a packet comprising an Internet Protocol (IP) header;
determining that the IP header comprises one or more options;
modifying an options indicator field in the IP header from a first options protocol value to a selected opaque protocol value; and
transmitting the packet.

2. The method of claim 1, wherein the method is implemented by an egress node of a sub-network, and the sub-network is a source sub-network of the packet.

3. The method of claim 1, wherein the IP header is an IP version 6 (IPv6) header, the one or more options comprises hop-by-hop header options, and the options indicator field is a Next Header Field.

4. The method of claim 1, further comprising inserting a flow identifier in the IP header to identify a packet flow.

5. The method of claim 1, wherein the IP header is an IP version 4 (IPv4) header, and the options indicator field is a Protocol field.

6. The method of claim 1, further comprising modifying at least one of an Internet Header Length (IHL) field from a first IHL value to a second IHL value indicating a minimum IHL length, a Header Checksum (HC) value from a first HC value to a second HC value, or a Total Length (TL) header field from a first TL value to a second TL value indicating an increase in a TL of the packet.

7. The method of claim 6, further comprising adding at least one of a new first field to the IP header for saving the first HC value, a new second field to the IP header for saving the first IHL value, or a new third field to the IP header for saving the first TL value.

8. The method of claim 7, wherein the new first field, the new second field, or the new third field are added in a trailer at an end of the packet.

9. A method comprising:
receiving a packet comprising an Internet Protocol (IP) header;
determining that an options indicator field in the IP header comprises a selected opaque protocol value;
modifying the options indicator field from the selected opaque protocol value to an options value indicating that the IP header comprises one or more options; and
transmitting the packet.

10. The method of claim 9, wherein the IP header is an IP version 6 (IPv6) header, the one or more options comprises hop-by-hop header options, and the options indicator field is a Next Header Field.

11. The method of claim 9, wherein the IP header is an IP version 4 (IPv4) header, and the options indicator field is a Protocol field.

12. The method of claim 9, further comprising modifying at least one of an Internet Header Length (IHL) field from a first IHL value to a second IHL value indicating an IHL length with the one or more options, a Header Checksum (HC) value from a first HC value to a second HC value, or a Total Length (TL) header field from a first TL value to a second TL value indicating decrease in a TL of the packet.

13. The method of claim 9, further comprising removing one or more fields that were previously added to the IP header.

14. The method of claim 9, wherein the method is implemented by an ingress node of a sub-network, and the sub-network is a destination sub-network of the packet.

15. A network node comprising:
a memory storing instructions; and
one or more processors coupled to the memory, wherein the one or more processors execute the instructions to cause the network node to:
receive a packet comprising an Internet Protocol (IP) header;
determine that the IP header comprises one or more options;
modify an options indicator field in the IP header from a first options protocol value to a selected opaque protocol value; and
transmit the packet.

16. The network node of claim 15, wherein the IP header is an IP version 6 (IPv6) header, the one or more options comprises hop-by-hop header options, and the options indicator field is a Next Header Field.

17. The network node of claim 15, wherein the IP header is an IP version 4 (IPv4) header, and the options indicator field is a Protocol field.

18. The network node of claim 15, the one or more processors execute the instructions to cause the network node to modify at least one of an Internet Header Length (IHL) field from a first IHL value to a second IHL value indicating a minimum IHL length, a Header Checksum (HC) value from a first HC value to a second HC value, or a Total Length (TL) header field from a first TL value to a second TL value indicating an increase in a TL of the packet.

19. The network node of claim 15, wherein the first options protocol value is 0.

20. The network node of claim 15, wherein the one or more processors execute the instructions to cause the network node to insert a flow identifier in the IP header to identify a packet flow.
